(19) United States
(12) Patent Application Publication
(10) Pub. No.: US 2026/0340107 A1
(43) Pub. Date: Oct. 29, 2026

(54) AI-Driven Identity and Access Credential Management and Orchestration System for Non-Human Identities

(71) Applicant: Timothy Trell Rohovit, Salt Lake City, UT (US)

(72) Inventor: Timothy Trell Rohovit, Salt Lake City, UT (US)

(21) Appl. No.: 19/548,694

(22) Filed: Feb. 24, 2026

Related U.S. Application Data
(60) Provisional application No. 63/762,941, filed on Feb. 25, 2025.

(51) Int. Cl. G06F 21/45; G06F 21/55

(52) U.S. Cl. CPC G06F 21/45; G06F 21/554; G06F 2221/034

(57) ABSTRACT

An AI-driven identity and access credential management and orchestration system for non-human identities (machines, software entities, and AI agents) comprising a centralized orchestration platform that governs distributed AI Identity and Access Credential Management Agents (AI IACM Agents). The system automates credential lifecycle management (discovery, issuance, renewal, rotation, revocation) and provides AI-driven on-demand authentication services. The orchestration platform and agents can operate within hardware-based secure enclaves (trusted execution environments) for enhanced security isolation. The system supports management of non-exportable cryptographic keys that remain within Hardware Security Modules (HSMs) or secure enclaves, with agents invoking cryptographic operations in-place without accessing raw key material. Integration with enterprise IAM infrastructure (IGA, PAM, SIEM, PKI) enables risk-based policy enforcement, anomaly detection, automated remediation, and continuous compliance tracking. The adaptive security model uses machine learning for threat detection and continuous feedback for self-healing credential security.

### CROSS-REFERENCE TO RELATED APPLICATION

This application claims priority to U.S. Provisional Application No. 63/762,941, filed Feb. 25, 2025, the entity of which is incorporated herein by specific reference.

### BACKGROUND

### 1. Technical Field

This invention relates to cybersecurity and identity and access management (IAM), specifically to an enterprise-wide AI-driven identity and access credential management and orchestration system that governs and automates the lifecycle of machine and software entity credentials, as well as provides automated, on-demand AI-driven authentication services. The system leverages distributed Artificial Intelligence Identity and Access Credential Management Agents (AI IACM Agents), centrally managed via an orchestration platform that can be deployed on-premises, in the cloud, in hybrid environments, or within secure enclave environments (hardware-based trusted execution environments). The system integrates with and utilizes other enterprise IAM and security systems—such as Credential Lifecycle Management (CLM), Identity Governance and Administration (IGA), Privileged Access Management (PAM), Security Information and Event Management (SIEM), cryptographic key management services, key stores, secrets management systems, and Hardware Security Modules (HSMs)—to ensure secure, automated identity credential lifecycle management and AI-driven on-demand authentication for machine and software entities (non-human identities), including general-purpose AI agents, across enterprise, cloud, and hybrid environments.

### 2. Background of the Invention

Existing Challenges in Non-Human Identity Management: Historically, machine identity management has focused on securing cryptographic credentials (e.g., X.509 certificates, SSH keys) for physical and virtual devices such as servers, network devices, middleware systems, IoT devices, and containers. However, modern IT environments introduce a broader category of non-human identities, including service accounts, APIs, scripts, bots, general-purpose AI agents and AI-driven autonomous systems, Operational Technology (OT) devices, autonomous systems, and robotic process automation (RPA) bots.

Current IAM frameworks struggle to effectively handle and automate credential lifecycle management and AI-driven on-demand authentication for these non-human identities due to:
Manual credential processes leading to human error, security gaps, and compliance vulnerabilities.
Lack of integration across enterprise security frameworks (IGA, PAM, PKI, SIEM, DevSecOps pipelines, key stores, and HSMs).
Absence of AI-driven, adaptive security models for anomaly detection, risk-based policy enforcement, and automated remediation.
Limited support for hardware-protected credential storage and non-exportable cryptographic keys that must remain within HSMs or secure enclaves.

Need for an AI-Driven Orchestration System: There is a need for an enterprise-wide orchestration system that centrally provisions, controls, and manages distributed AI IACM Agents. These agents would autonomously manage the full identity credential lifecycle and provide AI-driven, on-demand authentication services, including secure management of non-exportable cryptographic keys and operation within secure enclave environments.

### 3. Summary of the Invention

This invention introduces an advanced AI-driven Identity and Access Credential Management and Orchestration System specifically designed for non-human identities (machines, software entities, autonomous systems, general-purpose AI agents, APIs, and service accounts). The system fundamentally transforms credential management by leveraging intelligent software agents—AI Identity and Access Credential Management Agents (AI IACM Agents)—that autonomously manage the complete credential lifecycle and provide on-demand, just-in-time authentication services without requiring deployment of traditional credential automation protocols or scripts to target systems.

Core Innovation: The system leverages distributed AI IACM Agents centrally managed via an orchestration platform that can be deployed on-premises, in the cloud, in hybrid environments, or within secure enclave environments (hardware-based trusted execution environments). The orchestration platform integrates with and utilizes existing enterprise IAM and security systems—such as Credential Lifecycle Management (CLM), Identity Governance and Administration (IGA), Privileged Access Management (PAM), Security Information and Event Management (SIEM), cryptographic key management services, key stores, secrets management systems, and Hardware Security Modules (HSMs)—to ensure secure, automated identity credential lifecycle management and AI-driven on-demand authentication for machine and software entities across enterprise, cloud, and hybrid environments.

Paradigm Shift from Traditional Automation: Unlike conventional approaches that require deploying credential automation code, agents, or protocol implementations (such as ACME, SCEP, or custom scripts) directly to target servers and systems, this invention enables AI IACM Agents to present credentials and perform authentication operations on behalf of requesting systems directly to target resources. This eliminates the need for installing and maintaining credential management software on every endpoint. The AI agents act as intelligent intermediaries that understand evolving authentication protocols and standards, adapting automatically as industry standards change without requiring code updates across the enterprise infrastructure.

Advanced Security Features: The system supports deployment within hardware-based secure enclaves (trusted execution environments such as Intel SGX, AMD SEV, ARM TrustZone, or equivalent technologies) for enhanced security isolation. Additionally, the system manages both exportable credentials and non-exportable cryptographic keys that remain permanently within Hardware Security Modules (HSMs) or secure cryptographic tokens, with agents invoking cryptographic operations in-place without accessing raw key material. These security features provide defense-in-depth protection while maintaining the flexibility of AI-driven credential orchestration.

Adaptive Intelligence and Standards Evolution: The AI-driven adaptive security model continuously learns from credential usage patterns, security events, and threat intelligence to improve risk scoring and remediation strategies. As authentication protocols, cryptographic standards, and compliance frameworks evolve, the system's machine learning capabilities enable it to adapt to new standards (including post-quantum cryptographic algorithms and protocols) and potentially recommend optimal credential management strategies based on historical analysis and emerging security requirements. This future-proof architecture ensures the system remains effective as technology and security landscapes change.

Secure Enclave Support: The orchestration platform and/or the AI IACM Agents can operate inside hardware-based secure enclaves (trusted execution environments or TEEs) for additional isolation. Secure enclaves provide hardware-enforced confidentiality and integrity, protecting the agent's code execution and stored data from the host operating system and other processes. This ensures that even if the host system is compromised, the agent's operations and the credentials it manages remain confidential and tamper-resistant. The system supports multiple deployment configurations: agents running in secure enclaves while the orchestration system operates externally, the entire orchestration platform running within secure enclaves, or hybrid combinations based on security requirements.

Non-Exportable Key Management: The system supports managing cryptographic keys that remain non-exportable—that is, keys that never leave Hardware Security Modules (HSMs), secure cryptographic tokens, or secure enclave environments. When using non-exportable keys, the AI IACM Agents invoke cryptographic operations (such as signing, encryption, or decryption) within the secure hardware module itself, receiving only the results of the operation without ever accessing the raw key material. This design ensures that sensitive cryptographic keys are protected from extraction even in the event of a host system compromise. The system also supports exportable keys stored in software-based secure vaults or key stores, applying the same AI-driven lifecycle and on-demand authentication logic to both key types.

Deployment Flexibility: The orchestration platform can act as an independent credential broker without requiring third-party proxy components, while still maintaining the ability to integrate with existing credential management infrastructure (such as existing secrets managers, PKI services, or HSM pools). The system provides centralized governance, administration, and control over AI IACM Agents via an enterprise-wide orchestration management platform.

The AI-driven credential management orchestration system can be deployed in various environments:
1. On-Premises: Within an organization's internal infrastructure.
2. Cloud: As a cloud-based or multi-tenant SaaS solution.
3. Hybrid: A combination of on-premises and cloud-based components.
4. Secure Enclave: Components deployed within hardware-based trusted execution environments for enhanced security isolation.

Key functionalities include:
Automated Credential Lifecycle Management: End-to-end automation of credential discovery, issuance, renewal, revocation, rotation, and expiration management for both exportable and non-exportable credentials.
Secure Credential Retrieval and Usage: Including credentials stored in HSMs with non-exportable key material where agents invoke cryptographic operations in-place.
Enterprise-Wide Orchestration: Centralized coordination across on-premises, cloud, hybrid, and secure enclave environments.
Integration with Enterprise Systems: Seamless integration with IGA, PAM, PKI, SIEM, HSMs, and secure vaults.
AI-Driven Policy Enforcement: Dynamic security policy enforcement with anomaly detection and risk-based decisions.
Automated Threat Remediation: Automatic remediation actions including key rotation, credential revocation, and system reconfiguration.

Additional features and advantages of the embodiments of the invention will be set forth in the description which follows or may be learned by the practice of such embodiments. The features and advantages of such embodiments may be realized and obtained by means of the instruments and combinations particularly pointed out in the appended claims. These and other features will become more fully apparent from the following description and appended claims or may be learned by the practice of such embodiments as set forth hereinafter.

Example embodiments are described below with reference to the accompanying drawings. Many different forms and embodiments are possible without deviating from the spirit and teachings of this disclosure and so the disclosure should not be construed as limited to the example embodiments set forth herein. Rather, these example embodiments are provided so that this disclosure will be thorough and complete, and will convey the scope of the disclosure to those skilled in the art. In the drawings, the sizes and relative sizes of layers and regions may be exaggerated for clarity. Like reference numbers refer to like elements throughout the description. Unless defined otherwise, all terms (including technical and scientific terms) used herein have the same meaning as commonly understood by one of ordinary skill in the art to which the present disclosure pertains. It will be further understood that terms, such as those defined in commonly used dictionaries, should be interpreted as having a meaning that is consistent with their meaning in the context of the present application and relevant art and should not be interpreted in an idealized or overly formal sense unless expressly so defined herein. The terminology used in the description of the invention herein is for the purpose of describing particular embodiments only and is not intended to be limiting of the invention. While a number of methods and materials similar or equivalent to those described herein can be used in the practice of the present disclosure, only certain exemplary materials and methods are described herein.

All publications, patent applications, patents or other references mentioned herein are incorporated by reference in their entirety. In case of a conflict in terminology, the present specification is controlling.

Various aspects of the present disclosure, including devices, systems, methods, etc., may be illustrated with reference to one or more exemplary implementations. As used herein, the terms “exemplary” and “illustrative” mean “serving as an example, instance, or illustration,” and should not necessarily be construed as preferred or advantageous over other implementations disclosed herein. In addition, reference to an “implementation” or “embodiment” of the present disclosure or invention includes a specific reference to one or more embodiments thereof, and vice versa, and is intended to provide illustrative examples without limiting the scope of the invention, which is indicated by the appended claims rather than by the following description.

It will be noted that, as used in this specification and the appended claims, the singular forms “a,” “an,” and “the” include plural referents unless the content clearly dictates otherwise.

As used throughout this application the words “can” and “may” are used in a permissive sense (i.e., meaning having the potential to), rather than the mandatory sense (i.e., meaning must). Additionally, the terms “including,” “having,” “involving,” “containing,” “characterized by,” variants thereof (e.g., “includes,” “has,” “involves,” “contains,” etc.), and similar terms as used herein, including the claims, shall be inclusive and/or open-ended, shall have the same meaning as the word “comprising” and variants thereof (e.g., “comprise” and “comprises”), and do not exclude additional, un-recited elements or method steps, illustratively.

As used herein, directional and/or arbitrary terms, such as “top,” “bottom,” “left,” “right,” “up,” “down,” “upper,” “lower,” “inner,” “outer,” “internal,” “external,” “interior,” “exterior,” “proximal,” “distal,” “forward,” “reverse,” and the like can be used solely to indicate relative directions and/or orientations and may not be otherwise intended to limit the scope of the disclosure, including the specification, invention, and/or claims.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present embodiments.

The term “about” is used herein to mean approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 5%. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. The word “or” as used herein means any one member of a particular list and also includes any combination of members of that list.

It is also understood that various implementations described herein can be used in combination with any other implementation described or disclosed, without departing from the scope of the present disclosure. Therefore, products, members, elements, devices, apparatus, systems, methods, processes, compositions, and/or kits according to certain implementations of the present disclosure can include, incorporate, or otherwise comprise properties, features, components, members, elements, steps, and/or the like described in other implementations (including systems, methods, apparatus, and/or the like) disclosed herein without departing from the scope of the present disclosure. Thus, reference to a specific feature in relation to one implementation should not be construed as being limited to applications only within said implementation.

The headings used herein are for organizational purposes only and are not meant to be used to limit the scope of the description or the claims. To facilitate understanding, like reference numerals have been used, where possible, to designate like elements common to the figures. Furthermore, where possible, like numbering of elements have been used in various figures. Furthermore, alternative configurations of a particular element may each include separate letters appended to the element number.

### 4. Technical Architecture

### 4.1 Enterprise-Wide Identity and Access Orchestration Management System

The orchestration system serves as the centralized enterprise governance, administration, and command-and-control system. It manages identity credential lifecycle and AI-driven on-demand authentication services for cryptographic keys (including asymmetric keys such as PKI certificates and SSH key pairs, symmetric encryption keys, and non-exportable HSM-managed keys), secrets, passwords, privileged credentials, and IAM-managed credentials.
Agent Deployment and Integration: Deployment and management of AI IACM Agents across diverse environments including secure enclaves.
Policy Distribution for Key Handling: Provision of policies for both exportable and non-exportable key handling.
Continuous Policy Enforcement: Adaptive security controls to mitigate evolving threats.
Unified Governance: Single governance layer with real-time monitoring and compliance tracking.

### 4.2 AI Identity and Access Credential Management Agents (AI IACM Agents)

Distributed Autonomous Agents: Agents operate autonomously and can run in standard host environments or within isolated secure enclaves.
A. Automated Lifecycle Management: Full lifecycle management including discovery, issuance, renewal, rotation, revocation for cryptographic keys (asymmetric keys, symmetric keys, exportable and non-exportable), secrets, passwords, and IAM-managed credentials.
B. On-Demand Authentication Services: Dynamic real-time authentication with secure credential retrieval, support for any authentication protocol or interface the target system requires (including but not limited to TLS, SSH, OAuth), and zero-trust enforcement.

### 4.3 Agent-to-Orchestration Communication Protocol

Mutual Authentication: Agents and orchestration platform establish mutual TLS authentication using X.509 certificates (or equivalent cryptographic authentication standards) or cryptographic attestation tokens issued during agent provisioning.
Secure Command Channel: All policy distribution, configuration updates, and remediation commands flow through encrypted channels with message-level integrity verification.
Heartbeat & Status Reporting: Agents maintain persistent connections with configurable heartbeat intervals, reporting health status, credential inventory changes, and security events.
Agent Identity Verification: Each agent possesses a unique cryptographic identity that cannot be spoofed, enabling the orchestration platform to track and audit all agent activities across the enterprise.
Failure Recovery: In the event of disconnection, agents cache policies locally and continue autonomous operations within defined safety boundaries until reconnection is established.

### 4.3.1 Eliminating Traditional Credential Automation Deployment

Traditional Credential Management Limitations: Conventional credential automation approaches require deploying credential management code, scripts, or protocol clients (such as ACME clients for certificate automation, SCEP clients for device enrollment, or equivalent automation tools, or custom credential rotation scripts) directly onto target servers, containers, virtual machines, and IoT devices. This creates significant operational burdens including maintaining code versions across heterogeneous systems, patching security vulnerabilities in deployed automation tools, managing dependencies and runtime environments on each endpoint, and coordinating updates when authentication protocols or standards evolve.

AI Agent Direct Authentication Model: This invention eliminates the need for endpoint-deployed credential automation by enabling AI IACM Agents to perform authentication and credential presentation operations on behalf of requesting systems. When a non-human identity (such as an API, service account, AI agent, or autonomous system) needs to authenticate to a target resource, the AI IACM Agent retrieves or generates the appropriate credential just-in-time and presents it directly to the target system as if it were the requesting entity. The target system receives valid authentication credentials without requiring any credential management software to be installed locally.

Protocol Independence and Evolution: Because the AI agents centrally manage credential operations under orchestration platform control, the system is inherently protocol-agnostic. The agents authenticate to and interact with any enterprise infrastructure system—certificate authorities, HSMs, vaults, IAM platforms, SIEM systems—using whatever native interface or authentication method that system exposes. This is the same agent-mediated authentication model used for target non-human identities: the agent presents valid credentials to the infrastructure system and performs the required operation, regardless of the specific protocol involved. As protocols evolve or new standards emerge, only the orchestration platform and agents require updates—the thousands or millions of endpoints using credentials benefit from protocol improvements automatically without any changes to target systems or requesting applications. This architectural approach also positions the system to potentially recommend or implement novel authentication patterns learned through machine learning analysis of enterprise authentication flows and security outcomes.

Reduced Attack Surface: Eliminating credential automation software from endpoints reduces the attack surface by removing potential vulnerabilities in deployed automation tools, preventing attackers from compromising credential management logic running on target systems, and centralizing all credential operation logic in secured orchestration platform and agents (optionally within secure enclaves). This centralized, agent-mediated approach provides superior security compared to distributed automation scripts.

### 4.4 AI-Driven Adaptive Security Model

Continuous Anomaly Monitoring: Detection of anomalies and indicators of compromise.
Dynamic Policy Adjustment: Machine learning-driven analytics for dynamic security policy adjustment.
Risk Scoring: Continuous risk assessment and scoring.
Automated Remediation: Automatic execution of remediation workflows.

### 4.5 Integration Architecture Patterns

The system employs a protocol-agnostic integration architecture in which AI IACM Agents authenticate to and interact with enterprise infrastructure systems using whatever native interface or authentication method each system exposes. The agents serve as universal authentication intermediaries, abstracting protocol complexity away from the endpoints they serve. Because all protocol logic is centralized within the agents and orchestration platform, the system can adapt to new interfaces, evolving standards, or proprietary APIs without any changes to target systems. The following are examples of integration patterns the agents may utilize, but the system is not limited to these specific protocols or interfaces:
A. API-Based Integration: The orchestration platform and AI IACM Agents may integrate with IGA, PAM, and SIEM systems through their native APIs and interfaces. Examples include RESTful APIs with OAuth 2.0 or equivalent authorization frameworks, SCIM (System for Cross-domain Identity Management) or equivalent identity synchronization protocols, webhook-based event notifications, and GraphQL interfaces. The agents authenticate to these systems using the system's native authentication mechanisms, just as they would authenticate to any target resource on behalf of a non-human identity.
B. Protocol-Based Integration: For PKI and certificate authority systems, the agents interact using whatever certificate management interface the CA exposes. Examples include ACME (Automated Certificate Management Environment), EST (Enrollment over Secure Transport), CMP (Certificate Management Protocol), and OCSP (Online Certificate Status Protocol). Critically, these protocol interactions occur within the AI IACM Agent—not on the endpoints that consume the certificates. The endpoints require no protocol client software; the agent handles all CA interactions on their behalf.
C. Hardware and Vault Integration: For HSMs and secure vaults, the agents interact through whatever interface the hardware or vault system provides. Examples include PKCS #11 or equivalent cryptographic token interfaces, KMIP (Key Management Interoperability Protocol), and vendor-specific SDKs (such as AWS KMS, Azure Key Vault, HashiCorp Vault) accessed through a vendor abstraction layer. The agents authenticate to these systems as any authorized client would, using the credentials and access methods provisioned by the orchestration management system.
D. Event-Driven Integration: For SIEM and monitoring systems, the agents and orchestration platform deliver telemetry and audit data using whatever ingestion interface the monitoring system supports. Examples include Syslog/CEF (Common Event Format) for audit logging, message queue integration for high-volume telemetry, and OpenTelemetry for distributed tracing and metrics.
E. Conflict Resolution: When multiple systems claim authority over credential decisions, the orchestration platform maintains a policy hierarchy where enterprise-level policies override system-specific policies. Agents query the orchestration platform as the authoritative source for all access decisions. The system implements eventual consistency with rollback capabilities if conflicting actions are detected.

### 4.5.1 Post-Quantum Cryptography and Cryptographic Agility

The system is designed with cryptographic agility to support both classical cryptographic algorithms and post-quantum cryptographic (PQC) algorithms and protocols as they become standardized and adopted by industry:

Dual Algorithm Support: The system supports managing credentials and performing cryptographic operations using both classical algorithms (RSA, ECDSA, AES, SHA-256, or equivalent standards) and post-quantum algorithms (such as CRYSTALS-Kyber for key encapsulation, CRYSTALS-Dilithium for digital signatures, SPHINCS+for hash-based signatures, or equivalent NIST-approved PQC standards and successors).

Hybrid Cryptography: The system can employ hybrid cryptographic approaches that combine classical and post-quantum algorithms to provide security against both conventional and quantum computing threats. For example, key exchange might use both ECDH and Kyber, with security depending on the hardness of either problem.

Algorithm Lifecycle Management: AI IACM Agents manage the lifecycle of cryptographic algorithms themselves, monitoring for algorithm deprecation announcements, security vulnerabilities, or quantum computing advances that necessitate migration to stronger algorithms. The orchestration platform can coordinate enterprise-wide algorithm transitions, gradually rotating credentials from deprecated algorithms to quantum-resistant alternatives.

HSM and Secure Enclave PQC Support: The system integrates with HSMs and secure enclaves that provide hardware-accelerated post-quantum cryptographic operations. As hardware vendors implement PQC support, the system automatically utilizes these capabilities without requiring changes to the orchestration logic or agent deployment.

Protocol Agility: Secure communication channels between agents and the orchestration platform, and between agents and target systems, support protocol negotiation to select the strongest mutually-supported cryptographic suite. This includes classical TLS 1.3 (or successors), hybrid TLS with PQC key exchange, or future quantum-resistant secure communication protocols as they emerge and gain industry acceptance.

### 4.5.2 AI Agent Integration Architecture and MCP-Compatible Services

The orchestration platform and AI IACM Agents support multiple integration paradigms to access enterprise IAM resources and external systems:

Native System Integration: AI IACM Agents can access existing IAM resources directly through native system APIs, SDKs, and protocols using system-level rights and credentials provisioned by the orchestration platform. This approach provides maximum performance and minimal architectural complexity for environments where agents have appropriate system permissions.

MCP Server Compatibility: The orchestration platform can function as an MCP (Model Context Protocol) server or equivalent AI agent integration service, exposing credential management capabilities as standardized tools and resources that other AI systems can utilize. This enables the system to serve as a credential management backend for broader AI agent ecosystems, providing credential lifecycle operations, on-demand authentication services, and security policy enforcement as consumable AI agent tools.

MCP Client Integration: AI IACM Agents can optionally leverage existing MCP servers or equivalent AI agent integration services deployed in the enterprise to access specialized tools, data sources, or system capabilities. This allows agents to utilize established AI infrastructure while focusing their core logic on credential management and security orchestration.

Hybrid Integration Model: The system supports combining direct system access with MCP-style service integration, enabling agents to use the most appropriate integration method for each target system. For example, an agent might access an HSM directly via PKCS #11 (or equivalent) while simultaneously utilizing an MCP server to query a corporate knowledge base or ticketing system for context-aware credential decisions.

Standards-Agnostic Design: The integration architecture is designed to be agnostic to specific AI agent communication protocols. Whether using MCP, custom REST APIs, GraphQL, gRPC, or future AI agent integration standards, the system provides the same credential management and authentication capabilities through its abstraction layer. This ensures longevity as AI agent integration standards evolve.

### 4.6 Secure Enclave Deployment and Non-Exportable Key Management

This section describes the deployment configurations and key handling mechanisms that provide enhanced security through hardware-based isolation and non-exportable key protection.

### 4.6.1 Orchestration Management Provisions for Key Handling

The Orchestration Management system provisions AI IACM Agents with privileges and provides policies for both exportable and non-exportable key handling:
Policy-Based Key Classification: Policies classify credentials by exportability status, specifying whether key material may be extracted or must remain within secure hardware.
Privilege Assignment: Agents receive appropriate privileges to invoke HSM cryptographic operations without privileges to export underlying key material.
Secure Communication: All communications encrypted and authenticated using mutual TLS or equivalent protocols.

### 4.6.2 AI IACM Agent Execution Environments

Standard Host Environment: Agents execute as standard processes, still leveraging HSMs for non-exportable key operations.
Secure Enclave Environment: Agents execute within hardware-backed trusted execution environments providing isolated memory regions protected from host OS and hypervisor.
Hybrid Deployment: Mixed deployment based on sensitivity of managed systems and credentials.

### 4.6.3 Non-Exportable Key Storage and In-Place Cryptographic Operations

In-Place Cryptographic Operations: Agent sends operation request to HSM; HSM performs operation internally using protected key; only result returned. Key material never leaves HSM boundary.
Key Reference Handles: System uses key handles rather than actual key material. Handles cannot reconstruct keys.
Lifecycle Operations: Key generation, rotation, and destruction performed through HSM API without exposing key material.

### 4.6.4 Full Platform Secure Enclave Deployment (Optional)

Orchestration in Enclave: Central orchestration server runs within secure enclave with all policy management in hardware-isolated memory.
Agents in Enclaves: Each AI IACM Agent runs in secure enclave creating end-to-end trusted execution environment.
Remote Attestation: Enclave-to-enclave communication uses remote attestation to verify integrity and authenticity.

### 4.6.5 Coordination Between Secure Enclaves and HSMs

Layered Protection: Enclave protects agent processing; HSM protects long-term key material.
Secure Channel: Agent establishes secure channel to HSM from within enclave.
Combined Assurance: Host compromise cannot observe agent operations or extract HSM-protected keys.

### 4.6.6 Hardware-Agnostic Security Isolation

The term “secure enclave” encompasses various trusted execution environment technologies including CPU-based enclaves (Intel SGX, AMD SEV, ARM TrustZone), secure virtualization partitions, and secure co-processor modules that achieve hardware-enforced confidentiality and integrity.

### 4.6.7 Secure Enclave Implementation Details

Memory Isolation and Code Execution: The AI IACM Agent binary is loaded into enclave-protected memory pages marked as non-readable from outside the enclave. All credential data structures (key handles, policy caches, authentication tokens) reside in enclave memory. The host OS can schedule enclave code execution but cannot inspect or modify enclave memory contents. Page-level encryption ensures that even physical memory attacks cannot extract enclave data.

Enclave Entry and Exit: The agent exposes a minimal API surface for the host OS to invoke enclave functions (e.g., “process authentication request”). Data entering the enclave is copied into protected memory and validated. Data exiting the enclave is limited to operation results (signatures, authentication decisions) without exposing internal state. Side-channel protections prevent timing attacks and cache-based information leakage.

Remote Attestation Flow: When an agent initializes inside a secure enclave, it generates an attestation report containing a measurement (cryptographic hash) of the enclave code and initial data. The attestation is signed by the CPU's platform key (e.g., Intel EPID for SGX, AMD SEV attestation). The orchestration platform receives the attestation and verifies the signature is valid and chains to a trusted platform root, the measurement matches the expected agent binary and configuration, and the enclave security version is up-to-date. Only after successful attestation does the orchestration platform provision the agent with credentials and policies.

Orchestration-to-Agent Enclave Communication: Sensitive policy updates are encrypted using a key derived from the attestation process. Only the specific attested enclave can decrypt the policy data. This prevents man-in-the-middle attacks even if the host OS or network is compromised.

Performance Considerations: Enclave context switches incur latency (microseconds per operation). The system batches multiple credential operations to amortize enclave entry/exit overhead. For high-throughput scenarios, multiple enclave-resident agents can run in parallel. Agents cache policies and credentials within the enclave to minimize host interaction.

### 4.7 AI-Driven Adaptive Security Model Architecture

### 4.7.1 Machine Learning Components

The adaptive security model comprises multiple specialized machine learning subsystems:
A. Anomaly Detection Engine: Employs unsupervised learning algorithms (isolation forests, autoencoders, Gaussian mixture models) to establish baseline behavior for each credential and non-human identity. Continuously ingests telemetry from AI IACM Agents including credential access patterns (frequency, time-of-day, source IPs, requesting entities), cryptographic operation types and volumes, authentication success/failure rates, and privilege escalation attempts. Detects deviations from established baselines and assigns anomaly scores (0.0=normal, 1.0=highly anomalous).
B. Risk Scoring Model: Combines multiple risk factors using a weighted ensemble approach: credential sensitivity level (root keys, admin passwords =high risk), anomaly score from detection engine, context factors (geolocation, time, requesting application), and historical compromise indicators (past incidents, known attack patterns). Outputs a composite risk score that drives policy decisions.
C. Threat Intelligence Integration: Ingests external threat feeds (CVE databases, attack signatures, IoCs from SIEM). Correlates observed credential usage with known attack patterns (pass-the-hash, golden ticket, credential stuffing). Updates risk models dynamically as new threats emerge.
D. Reinforcement Learning for Remediation: Learns optimal remediation strategies by observing outcomes of past actions. Balances security (aggressive remediation) vs. operational continuity (minimize disruption). Adapts remediation policies based on enterprise-specific risk tolerance.

### 4.7.2 Feedback Loop Architecture

The adaptive security model operates in a continuous loop:
1. Data Collection: AI IACM Agents stream telemetry (credential events, access requests, cryptographic operations) to the orchestration platform
2. Feature Extraction: The system extracts relevant features (time-series patterns, graph relationships between entities)
3. Inference: ML models analyze features and compute anomaly scores, risk levels, and threat predictions
4. Decision: The orchestration system applies policy rules enhanced by ML outputs (e.g., “if risk >0.8, trigger immediate key rotation”)
5. Action: Commands are sent to agents to execute remediation (revoke, rotate, alert)
6. Outcome Observation: The system monitors whether the remediation resolved the issue or caused operational problems
7. Model Update: ML models are retrained using the outcome data, improving future predictions

### 4.7.3 Explainability and Auditability

All ML-driven decisions include explanations (e.g., “Credential X flagged because: 3x normal access frequency, new geographic location, time-of-day anomaly”)
Audit logs capture the input features, model version, and decision rationale for compliance review
Human operators can override ML decisions with justification logged for continuous learning

### 4.7.4 Privacy and Security of ML Models

Training data is anonymized and aggregated to protect sensitive credential details
ML models themselves are treated as sensitive assets and can be stored in secure enclaves
Model inference can run inside enclaves to prevent model extraction attacks

### 4.7.5 Standards Evolution and Adaptive Protocol Learning

Historical Learning from Authentication Patterns: The AI-driven adaptive security model analyzes historical credential usage, authentication success/failure patterns, and security incident data to identify inefficiencies or vulnerabilities in current authentication protocols and credential management practices. This analysis can reveal patterns such as protocols that consistently cause operational friction, authentication methods that correlate with security incidents, or credential types that are frequently mismanaged.

Protocol Optimization Recommendations: Based on machine learning analysis, the system can recommend optimal authentication strategies for specific use cases. For example, the system might identify that certain service-to-service authentication scenarios would benefit from shorter-lived credentials with more frequent rotation, or that particular credential types should transition to hardware-backed non-exportable keys based on observed compromise risk patterns.

Future Standards Adoption: As new authentication protocols, cryptographic standards (including post-quantum algorithms and equivalent emerging technologies), or credential management practices emerge, the system's machine learning models can evaluate their effectiveness by testing them in controlled scenarios and comparing security outcomes. This data-driven approach to standards adoption enables enterprises to make informed decisions about when to migrate to new technologies based on measured security improvements rather than vendor marketing or compliance mandates alone.

Potential for Novel Protocol Development: The system's comprehensive visibility into credential usage patterns, authentication flows, and security outcomes positions it to potentially identify novel authentication patterns or credential management strategies that could inform future industry standards. While the system primarily implements existing and emerging standards (or equivalent protocols), its machine learning capabilities could discover optimal approaches that are later formalized as industry best practices or standardized protocols.

### 4.8 Compliance and Regulatory Alignment

### 4.8.1 Regulatory Framework Support

The system provides built-in support for compliance with:

SOC 2 Type II (or equivalent audit frameworks): Complete audit trail of all credential lifecycle events. Separation of duties enforcement (agent operators cannot access credential material). Automated evidence collection for quarterly audits.

PCI DSS 4.0 (or equivalent payment card industry security standards): Cryptographic key management aligned with requirements 3.5, 3.6, 3.7. Access control logging per requirement 10.2. Quarterly key rotation enforcement per requirement 3.6.4.

HIPAA (or equivalent healthcare data protection regulations): Audit controls (§ 164.312(b)) through comprehensive logging. Integrity controls (§ 164.312(c)(1)) via HSM-backed signing. Transmission security (§ 164.312(e)) through credential-based encryption.

GDPR (or equivalent data privacy regulations): Privacy by design through minimal credential exposure. Right to erasure supported via automated credential revocation. Data breach notification automation when credential compromise is detected.

NIST Cybersecurity Framework: Identify (comprehensive credential inventory and discovery). Protect (cryptographic protection and access controls). Detect (AI-driven anomaly detection and threat intelligence). Respond (automated remediation workflows). Recover (credential restoration and incident recovery procedures).

### 4.8.2 Audit Trail Architecture

Immutable Logging: All credential events are logged to tamper-evident storage (blockchain-backed or append-only data stores). Logs include: timestamp, agent identity, credential identifier (not the credential itself), action taken, authorization basis, outcome. Log integrity is cryptographically verifiable.

Chain of Custody: Every credential operation includes a provenance chain showing who requested the operation (human or software entity), which policy authorized it, which agent executed it, what systems were affected, and what the outcome was.

Compliance Reporting: Automated generation of compliance reports (CSV, PDF, XLSX). Pre-built templates for common audit frameworks. Real-time compliance dashboards showing policy violations and remediation status.

### 5. BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings.

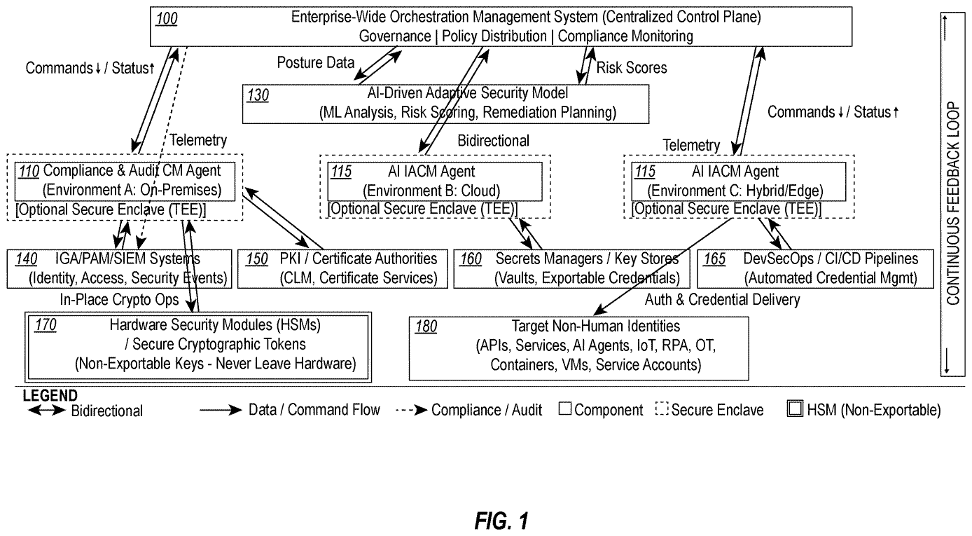

### FIG. 1—System Overview Diagram

FIG. 1 illustrates the overall architecture of the AI-Driven Identity and Access Credential Management and Orchestration System. The diagram shows the Enterprise-Wide Orchestration Management System operating as a centralized control plane at the top, providing governance, policy distribution, and compliance monitoring. Below it, a plurality of distributed AI IACM Agents operate autonomously in different environments (on-premises, cloud, and hybrid/edge), each optionally deployed within secure enclaves. Bidirectional communication channels connect the orchestration control plane to each agent, with policy and commands flowing down and telemetry and status flowing up. The AI-Driven Adaptive Security Model receives telemetry from the agents and provides risk scores and remediation plans to the orchestration system, which sends updated security posture data back, forming a continuous feedback loop. Integration with enterprise infrastructure including IGA/PAM/SIEM systems, PKI/Certificate Authorities, Secrets Managers/Key Stores, DevSecOps pipelines, and Hardware Security Modules is shown. The diagram illustrates the centralized governance with distributed operations architecture described in the claims.

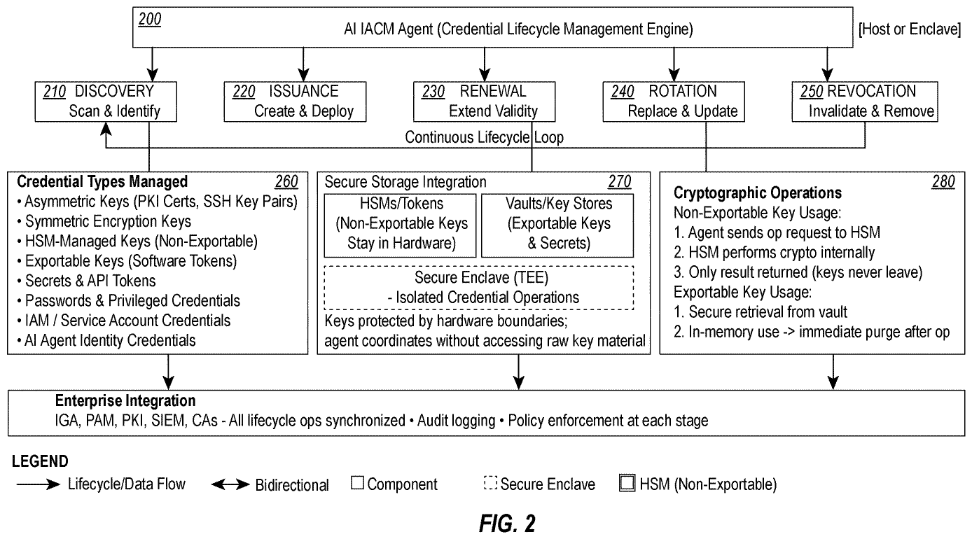

### FIG. 2—Credential Lifecycle Management Workflow

FIG. 2 depicts the credential lifecycle management workflow. The AI IACM Agent manages five phases: Discovery (scan and identify credentials), Issuance (create and deploy new credentials), Renewal (extend validity), Rotation (replace and update), and Revocation and Suspension (invalidate, suspend, and remove). The diagram shows how agents manage different credential types including asymmetric cryptographic keys (PKI certificates, SSH key pairs), symmetric encryption keys, HSM-managed non-exportable keys, exportable software tokens, secrets and API tokens, passwords and privileged credentials, IAM-managed credentials, and AI agent identity credentials. Integration with secure storage is shown, distinguishing between HSMs/Tokens (where keys remain inside and never leave) and Vaults/Stores (for exportable keys and secrets). Secure enclave deployment for isolated credential operations is also depicted. The workflow shows how non-exportable keys are used through in-place cryptographic operations where the agent sends requests to the HSM, the HSM performs operations internally, and only results are returned.

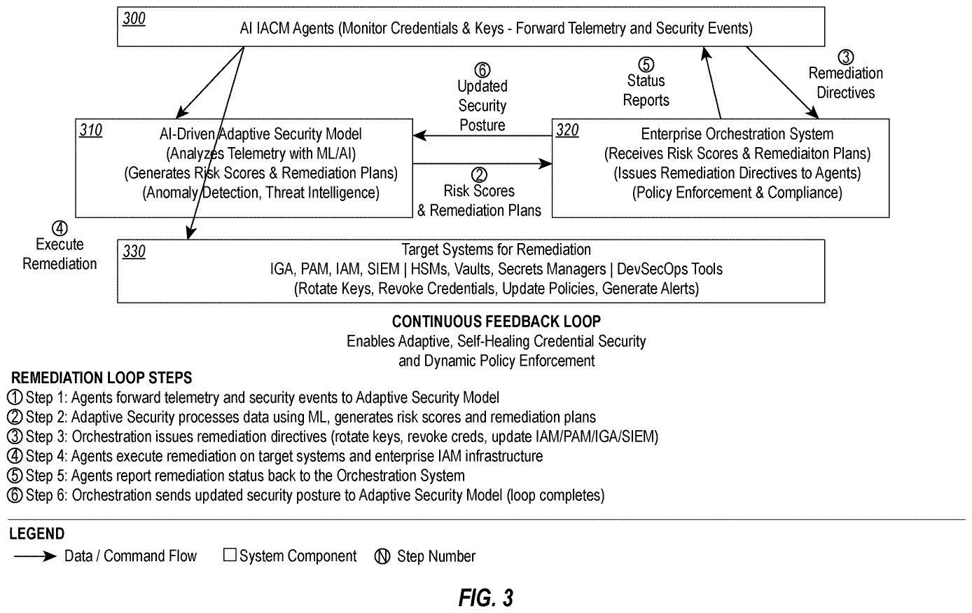

### FIG. 3—Adaptive Security and Automated Remediation Loop

FIG. 3 illustrates the continuous feedback loop for adaptive security and automated remediation. The loop consists of six steps: (1) AI IACM Agents forward telemetry and security events to the AI Adaptive Security Model; (2) The Adaptive Security Model processes this data using machine learning, generates risk scores, and creates remediation plans which are sent to the Orchestration System; (3) The Orchestration System issues remediation directives including commands to rotate keys, revoke credentials, and update IAM/PAM/IGA/SIEM systems; (4) Agents execute the remediation actions on target systems and enterprise IAM infrastructure; (5) Agents report remediation status back to the Orchestration System; (6) The Orchestration System sends updated security posture information to the Adaptive Security Model, completing the loop. This continuous process enables self-healing credential security and adaptive policy enforcement.

### 6. INVENTIVE ASPECTS

Aspect 1: Enterprise-Orchestrated AI Identity and Access Credential Management and Orchestration System
Aspect 2: Distributed Autonomous AI IACM Agent Operations
Aspect 3: Agent-Mediated On-Demand Authentication Without Endpoint Automation Deployment
Aspect 4: AI-Driven Adaptive Security with Continuous Machine Learning Feedback Loop
Aspect 5: Non-Human Identity Authentication Workflows
Aspect 6: Secure Enclave-Based Agent Deployment
Aspect 7: Full Secure Enclave Orchestration Platform Deployment
Aspect 8: Non-Exportable Key Management
Aspect 9: Agent-to-Orchestration Secure Communication Protocol
Aspect 10: Machine Learning Anomaly Detection and Environment-Specific Risk Scoring
Aspect 11: Protocol Independence and Adaptive Standards Evolution
Aspect 12: Enterprise Infrastructure Integration Architecture
Aspect 13: Compliance Monitoring and Immutable Audit Trail
Aspect 14: Method for AI-Driven Credential Lifecycle Management for Non-Human Identities
Aspect 15: Method for Adaptive Security Remediation of Non-Human Identity Credentials

While the foregoing detailed description makes reference to specific exemplary embodiments, the present disclosure may be embodied in other specific forms without departing from its spirit or essential characteristics. Accordingly, the described embodiments are to be considered in all respects only as illustrative and not restrictive. For instance, various substitutions, alterations, and/or modifications of the inventive features described and/or illustrated herein, and additional applications of the principles described and/or illustrated herein, which would occur to one skilled in the relevant art and having possession of this disclosure, can be made to the described and/or illustrated embodiments without departing from the spirit and scope of the invention as defined by the appended claims.

The limitations recited in the claims are to be interpreted broadly based on the language employed in the claims and not limited to specific examples described in the foregoing detailed description, which examples are to be construed as non-exclusive and non-exhaustive. All changes which come within the meaning and range of equivalency of the claims are to be embraced within their scope.

It will also be appreciated that various features of certain embodiments can be compatible with, combined with, included in, and/or incorporated into other embodiments of the present disclosure. For instance, systems, methods, and/or products according to certain embodiments of the present disclosure may include, incorporate, or otherwise comprise features described in other embodiments disclosed and/or described herein. Thus, disclosure of certain features relative to a specific embodiment of the present disclosure should not be construed as limiting application or inclusion of said features to the specific embodiment. In addition, unless a feature is described as being requiring in a particular embodiment, features described in the various embodiments can be optional and may not be included in other embodiments of the present disclosure. Moreover, unless a feature is described as requiring another feature in combination therewith, any feature herein may be combined with any other feature of a same or different embodiment disclosed herein.

I claim:

1. A system for managing identity and access credentials for non-human identities across enterprise computing environments, wherein non-human identities include machines, software entities, APIs, service accounts, AI agents, IoT devices, autonomous systems, and robotic process automation (RPA) bots, the system comprising:
(a) a centralized orchestration management system operating as an enterprise control plane that provides governance, policy distribution, and compliance monitoring for identity and access credential management across enterprise, cloud, and hybrid environments, wherein the orchestration management system maintains enterprise-defined security policies and distributes environment-specific policy configurations to a plurality of distributed agents;
(b) a plurality of distributed AI Identity and Access Credential Management (IACM) Agents, each agent operating autonomously within its assigned environment to perform identity credential lifecycle management and on-demand authentication services for non-human identities, wherein each agent manages cryptographic keys including asymmetric keys, symmetric keys, and both exportable and non-exportable keys, secrets, passwords, privileged credentials, and IAM-managed credentials, and wherein each agent operates under policy constraints received from the orchestration management system while adapting its operations to the specific risk profile and security requirements of its local environment;
(c) a bidirectional communication architecture between the orchestration management system and each AI IACM Agent, wherein the agents transmit real-time telemetry data including credential usage events, security events, authentication outcomes, and environment-specific risk indicators to the orchestration management system, and the orchestration management system transmits policy updates, remediation directives, and configuration commands to the agents through mutually authenticated and encrypted communication channels;
(d) protocol-agnostic integration capabilities through which the AI IACM Agents and the orchestration management system interoperate with existing enterprise identity and security infrastructure including Identity Governance and Administration (IGA) systems, Privileged Access Management (PAM) systems, Security Information and Event Management (SIEM) systems, Public Key Infrastructure (PKI) services, Hardware Security Modules (HSMs), secrets management systems, key stores, and secure vaults, wherein the agents authenticate to and interact with each infrastructure system using whatever native interface or authentication method the system exposes, and the orchestration management system synchronizes policy enforcement and compliance state across these systems;
(e) an AI-driven adaptive security model that receives telemetry from the plurality of AI IACM Agents, applies machine learning analysis to detect anomalies in credential usage patterns, generates composite risk scores for credentials and non-human identities, produces remediation plans, and provides risk-based intelligence to the orchestration management system, wherein the orchestration management system uses the adaptive security model outputs to dynamically adjust policies distributed to the agents, creating a continuous feedback loop between distributed credential operations and centralized risk-informed policy governance; and
(f) automated remediation capabilities wherein the orchestration management system, upon receiving risk assessments and remediation plans from the adaptive security model, directs the appropriate AI IACM Agents to execute environment-specific remediation actions including credential revocation, key rotation, privilege reduction, access policy modification, and updates to enterprise IGA, PAM, and SIEM systems, and wherein the agents report remediation outcomes back to the orchestration management system for verification and continuous model improvement;
whereby the system establishes centralized enterprise governance with distributed autonomous credential operations, enabling environment-specific risk-adaptive security responses while maintaining unified policy control and compliance visibility across the enterprise.

2. The system of claim 1, wherein:
(a) each AI IACM Agent performs full credential lifecycle management including automated discovery of existing credentials and unmanaged non-human identities, issuance and deployment of new credentials according to enterprise policy, renewal of credentials approaching expiration, rotation of credentials according to policy-defined schedules or in response to security events, and revocation and suspension of compromised or policy-violating credentials;
(b) each AI IACM Agent manages credential operations across multiple credential types simultaneously, including asymmetric cryptographic keys managed by PKI and certificate authority systems, SSH key pairs, symmetric encryption keys, HSM-managed non-exportable keys where cryptographic operations are performed in-place within the hardware module, exportable keys stored in software-based key stores and vaults, secrets and API tokens, passwords and privileged credentials managed through PAM integration, and IAM-managed service account credentials;
(c) each AI IACM Agent autonomously detects and remediates credential security vulnerabilities, potential compromises, and compliance deviations within its assigned environment based on policies received from the orchestration management system, and reports the detection and remediation actions to the orchestration management system for enterprise-wide visibility; and
(d) each AI IACM Agent caches policies locally and continues autonomous credential management operations within defined safety boundaries in the event of temporary disconnection from the orchestration management system, resuming full bidirectional communication upon reconnection and synchronizing any actions taken during the disconnection period.

3. The system of claim 1, wherein:
(a) the AI IACM Agents perform authentication and credential presentation operations on behalf of requesting non-human identities by retrieving or generating appropriate credentials just-in-time and presenting the credentials directly to target systems, thereby eliminating the requirement to deploy credential automation code, scripts, or protocol clients onto target servers, containers, virtual machines, or endpoint devices;
(b) the AI IACM Agents dynamically authenticate software entities, AI agents, services, machines, and devices without human intervention based on real-time access validation, authenticating to target systems using whatever native authentication protocol or interface the target system exposes, including but not limited to TLS, SSH, OAuth, and SAML, and enforcing continuous zero-trust privilege verification;
(c) the AI IACM Agents provide just-in-time credential retrieval with policy-defined automatic expiration, wherein credentials are provisioned for the minimum duration and minimum privilege scope necessary for the requested authentication operation; and
(d) the orchestration management system centrally manages the authentication protocol capabilities of the AI IACM Agents such that as authentication protocols evolve or new standards emerge, protocol updates are distributed from the orchestration management system to the agents without requiring changes to target systems or requesting applications across the enterprise infrastructure.

4. The system of claim 1, wherein the AI-driven adaptive security model comprises:
(a) an anomaly detection engine that employs machine learning algorithms to establish baseline behavior profiles for each credential and non-human identity based on telemetry received from the AI IACM Agents, and continuously evaluates incoming telemetry against the established baselines to detect deviations and assign anomaly scores;
(b) a risk scoring model that combines multiple risk factors including credential sensitivity level, anomaly scores from the detection engine, contextual factors, and historical compromise indicators to produce composite risk scores that drive policy decisions within the orchestration management system;
(c) a threat intelligence integration capability that ingests external threat feeds and correlates observed credential usage patterns with known attack patterns, dynamically updating the risk models as new threats emerge;
(d) a reinforcement learning component that learns optimal remediation strategies by observing outcomes of past remediation actions executed by the AI IACM Agents, balancing security responsiveness against operational continuity based on enterprise-specific risk tolerance; and
(e) a continuous feedback loop wherein the AI IACM Agents stream telemetry to the adaptive security model, the model generates risk assessments and remediation plans, the orchestration management system issues directives to agents based on the assessments, the agents execute remediation and report outcomes, and the model is updated based on the observed outcomes, thereby enabling self-improving, self-healing credential security that adapts to the specific risk characteristics of each enterprise environment over time.

5. The system of claim 1, wherein:
(a) the AI IACM Agents enable secure identity authentication workflows for non-human identity scenarios including API-to-API authentication, robotic process automation (RPA) credential handling, IoT device authentication, AI agent credential management, autonomous system credential management, and service-to-service authentication within DevSecOps and CI/CD pipelines;
(b) the AI IACM Agents apply AI-driven identity trust modeling that evaluates the trustworthiness of each non-human identity requesting authentication based on historical behavior, risk scores from the adaptive security model, current security posture, and enterprise policy constraints;
(c) the orchestration management system enforces authentication workflow compliance with enterprise security frameworks including DevSecOps pipelines and CI/CD security requirements; and
(d) the system maintains continuous security posture evaluation for each non-human identity, enabling the orchestration management system to dynamically adjust authentication requirements, credential lifetimes, and privilege scopes based on real-time risk assessments from the adaptive security model.

6. The system of claim 1, wherein:
(g) one or more of the AI IACM Agents are deployed within secure enclave environments on host computing platforms, wherein each secure enclave is a hardware-backed isolated execution environment that provides hardware-enforced confidentiality and integrity protections for the agent's code execution and stored data from the host operating system, hypervisor, and other processes;
(h) the centralized orchestration management system operates either (i) outside of the secure enclaves while maintaining secure, attested communication with each enclave-resident AI IACM Agent, or (ii) within its own secure enclave environment, coordinating with agent enclaves through remote attestation protocols that verify the integrity and authenticity of each party;
(i) sensitive credential operations including key usage, authentication handshakes, and policy enforcement logic execute entirely within the enclave boundaries, keeping credentials and cryptographic operations protected from observation or tampering by the host system; and
(j) the secure enclave implementation is hardware-agnostic, encompassing CPU-based enclaves such as Intel SGX, AMD SEV, and ARM TrustZone, secure virtualization partitions, and secure co-processor modules that provide equivalent hardware-enforced isolation.

7. The system of claim 1, wherein:
(k) the orchestration management system and the AI IACM Agents are together deployed within secure enclave environments such that the entire identity and access orchestration platform operates inside one or more hardware-protected enclaves, with both the central orchestrator and the distributed agent processes executing in isolated memory regions protected from external observation or interference by the host operating system or hypervisor;
(l) all credential management, storage, and authentication operations are contained within the secure enclaves, wherein cryptographic keys and credentials used by the system remain inside enclave or HSM boundaries and are never present in plaintext outside of the protected environments;
(m) communication between the orchestration enclave and agent enclaves uses remote attestation mechanisms to mutually verify the integrity and authenticity of each enclave before exchanging sensitive policy data, commands, or telemetry; and
(n) this configuration creates an end-to-end trusted execution environment for identity and access management processes, minimizing the trust surface by eliminating reliance on the host operating system or hypervisor for confidentiality and integrity of credential management operations.

8. The system of claim 1, wherein:
(o) cryptographic keys managed by the AI IACM Agents include non-exportable keys stored in Hardware Security Modules (HSMs), secure cryptographic tokens, or secure enclave protected storage, wherein the key material cannot be extracted from the secure storage and the AI IACM Agents perform cryptographic operations including signing, encryption, decryption, and key derivation in-place within the hardware module or secure enclave, receiving only the results of operations without accessing raw key material;
(p) the AI IACM Agents and the orchestration management system coordinate credential management tasks using key reference handles or identifiers rather than actual key material when referring to non-exportable keys, wherein the agents invoke HSM or secure enclave cryptographic functions to perform operations internally, ensuring that sensitive keys remain confined to certified hardware or secure enclave environments at all times;
(q) the system manages exportable keys stored in software-based secure vaults, key stores, or software tokens under the same AI-driven lifecycle management and on-demand authentication logic, wherein exportable keys are securely retrieved, used in-memory with immediate purge after operations, and rotated and revoked according to enterprise policies distributed by the orchestration management system;
(r) lifecycle operations for non-exportable keys, including key generation, rotation, and destruction, are performed through the HSM or secure enclave API without exposing key material; and
(s) the system provides layered protection such that compromise of an agent's host system does not enable extraction of non-exportable cryptographic keys from the trusted hardware boundaries, and when agents operate within secure enclaves, the enclave protects agent processing logic while the HSM protects long-term key material.

9. The system of claim 2, wherein:
(a) the AI IACM Agents and the orchestration management system establish mutual authentication using X.509 certificates or cryptographic attestation tokens issued during agent provisioning;
(b) each AI IACM Agent possesses a unique cryptographic identity that enables the orchestration management system to individually track and audit all agent activities across the enterprise;
(c) the agents maintain persistent connections to the orchestration management system with configurable heartbeat intervals, reporting health status, credential inventory changes, and security events in real time; and
(d) the bidirectional communication channel employs message-level integrity verification in addition to transport-level encryption, ensuring that policy updates, remediation commands, and telemetry data cannot be altered in transit.

10. The system of claim 4, wherein:
(a) the anomaly detection engine ingests credential telemetry including credential access patterns, frequency, time-of-day distributions, source network addresses, requesting entity identities, cryptographic operation types and volumes, authentication success and failure rates, and privilege escalation attempts;
(b) the risk scoring model applies a weighted ensemble approach combining credential sensitivity level, anomaly scores, geolocation context, time context, requesting application identity, and historical compromise indicators specific to each agent's operating environment to produce environment-aware composite risk scores; and
(c) the adaptive security model correlates risk scores across multiple AI IACM Agents operating in different environments to detect enterprise-wide attack patterns that would not be visible from any single agent's local telemetry alone, enabling the orchestration management system to coordinate cross-environment remediation responses.

11. The system of claim 3, wherein:
(a) the agent-mediated authentication architecture is protocol-agnostic, enabling the agents to interact with any enterprise infrastructure system or target resource using its native interface, and enabling the system to support new authentication protocols and cryptographic standards, including post-quantum cryptographic algorithms, by updating the orchestration management system and AI IACM Agents without requiring modifications to target systems, requesting applications, or endpoint-deployed automation software;
(b) the system supports cryptographic agility through concurrent management of credentials using both classical cryptographic algorithms and post-quantum algorithms, enabling hybrid cryptographic approaches and enterprise-wide algorithm migration coordinated by the orchestration management system; and
(c) the adaptive security model analyzes historical authentication patterns to identify protocol inefficiencies or security vulnerabilities and recommends optimal authentication strategies tailored to specific use cases and environments.

12. The system of claim 1, wherein the AI IACM Agents and orchestration management system interact with enterprise infrastructure systems using whatever native interface or authentication method each system exposes, and wherein exemplary integration patterns include:
(a) API-based integration with IGA, PAM, and SIEM systems through their native APIs, including but not limited to RESTful APIs, SCIM protocol for identity synchronization, and webhook-based event notifications;
(b) protocol-based integration with PKI and certificate authority systems through their native certificate management interfaces, including but not limited to ACME, EST, CMP, and OCSP protocols, wherein the agents handle all protocol interactions on behalf of endpoints that consume the certificates;
(c) hardware and vault integration with HSMs and secure vaults through their native cryptographic interfaces, including but not limited to PKCS #11 and KMIP interfaces, with a vendor abstraction layer supporting multiple HSM and vault providers; and
(d) event-driven integration with SIEM and monitoring systems through their native ingestion interfaces, including but not limited to syslog, CEF, message queue, and OpenTelemetry interfaces for audit logging, high-volume telemetry, and distributed tracing.

13. The system of claim 1, wherein:
(a) the orchestration management system maintains an immutable audit trail wherein all credential lifecycle events are logged to tamper-evident storage with cryptographically verifiable integrity, each log entry recording timestamp, agent identity, credential identifier, action performed, policy authorization basis, and outcome;
(b) each credential operation includes a provenance chain documenting the requestor identity, the authorizing policy, the executing agent, the affected systems, and the operation outcome;
(c) the system provides automated compliance reporting aligned with regulatory frameworks including SOC 2, PCI DSS, HIPAA, GDPR, and NIST Cybersecurity Framework; and
(d) human operators can override ML-driven decisions through the orchestration management system with justification captured in the audit trail and fed back to the adaptive security model for continuous learning.

14. A method for managing identity and access credentials for non-human identities across enterprise computing environments, wherein non-human identities include machines, software entities, APIs, service accounts, AI agents, IoT devices, and autonomous systems, the method comprising:
(a) deploying, from a centralized orchestration management system, a plurality of AI Identity and Access Credential Management (IACM) Agents across enterprise, cloud, and hybrid environments, each agent provisioned with environment-specific policies governing credential lifecycle management and on-demand authentication for non-human identities;
(b) performing, by each AI IACM Agent operating autonomously within its assigned environment, credential lifecycle operations comprising discovery of existing credentials, issuance of new credentials, renewal of expiring credentials, rotation of credentials, and revocation of compromised credentials, across credential types including asymmetric cryptographic keys, symmetric encryption keys, secrets, passwords, privileged credentials, and IAM-managed credentials;
(c) transmitting, from each AI IACM Agent to the orchestration management system, real-time telemetry comprising credential usage events, authentication outcomes, security events, and environment-specific risk indicators through mutually authenticated and encrypted communication channels;
(d) analyzing, by an AI-driven adaptive security model receiving the telemetry from the plurality of agents, credential usage patterns using machine learning to detect anomalies, generate risk scores, and produce remediation plans;
(e) directing, by the orchestration management system based on outputs from the adaptive security model, the appropriate AI IACM Agents to execute environment-specific remediation actions including credential revocation, key rotation, privilege reduction, and updates to enterprise identity and security systems;
(f) receiving, at the orchestration management system, remediation outcome reports from the AI IACM Agents, and providing the outcomes to the adaptive security model to update its models, thereby completing a continuous feedback loop between distributed operations and centralized risk analysis; and
(g) dynamically adjusting, by the orchestration management system, the policies distributed to the AI IACM Agents based on the updated risk assessments from the adaptive security model, enabling environment-specific, risk-adaptive credential management under unified enterprise governance.

15. A method for continuously detecting and remediating security threats to non-human identity credentials, including credentials held by machines, software entities, AI agents, and autonomous systems, across enterprise computing environments, the method comprising:
(a) collecting, by a plurality of distributed AI IACM Agents, telemetry data comprising credential access patterns, authentication success and failure events, cryptographic operation logs, and privilege usage data from across enterprise, cloud, and hybrid environments;
(b) streaming the collected telemetry data from the AI IACM Agents to an AI-driven adaptive security model through a centralized orchestration management system;
(c) analyzing, by the adaptive security model, the telemetry data using machine learning algorithms to establish baseline behavior for each non-human identity, detect deviations from established baselines, assign anomaly scores, compute composite risk scores incorporating credential sensitivity, contextual factors, and threat intelligence, and generate remediation plans;
(d) issuing, by the orchestration management system based on the remediation plans, environment-specific remediation directives to the appropriate AI IACM Agents, the directives comprising commands to rotate cryptographic keys, revoke compromised credentials, modify access policies, reduce privileges, and update enterprise IGA, PAM, and SIEM systems;
(e) executing, by the directed AI IACM Agents, the remediation actions on target systems and enterprise identity infrastructure within their respective environments;
(f) reporting, by the AI IACM Agents, remediation outcomes to the orchestration management system including confirmation of completed actions, identification of any operational impacts, and updated credential status;
(g) updating, based on the remediation outcomes, the adaptive security model to improve future anomaly detection, risk scoring, and remediation strategy selection; and
(h) repeating steps (a) through (g) as a continuous feedback loop, whereby the system progressively improves its ability to detect and remediate credential security threats specific to each environment while maintaining centralized enterprise governance and compliance visibility.
